(19) United States
(12) Patent Application Publication
(10) Pub. No.: US 2002/0198789 A1
(43) Pub. Date: Dec. 26, 2002

(54) Apparatus and method for identifying and purchasing music

(75) Inventor: Julian D. Waldman, Hopewell, NJ (US)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Sony Corp. and Sony Music Entertainment, Inc.

(21) Appl. No.: 09/888,352

(22) Filed: Jun. 22, 2001

(51) Int. Cl. G06F 17/60

(52) U.S. Cl. 705/26

(57) ABSTRACT

A portable communications device enables identification and purchasing of a full audio work from a sampled portion of the work. The device includes an input for receiving a sampled portion of a full audio work, a memory for storing the sampled portion, a communications module for communicating with an audio recognition service and/or an audio purchasing service, an input device for user commands, an interface such as display and a processor. The portable device records and stores the sampled portion and uploads the sample to the audio recognition service, or compares the sampled portion to a local database, to identify the full audio work from the sampled portion. The device displays identification information about the identity of the full audio work and purchasing information to allow purchase of the full audio work. A method and system incorporating the portable device are also disclosed.

### BACKGROUND OF THE INVENTION

The present invention relates to identifying and purchasing audio works and, more particularly, to a portable communications device for use in a system that identifies a full audio work based on a sampled portion of the audio work and allows automatic purchasing and/or downloading of the identified audio work.

Individuals may come to hear, identify and buy songs or audio works in many different ways. For example, an individual can visit a music store, browse through the store's inventory of CDs, cassettes, albums, etc. and locate music that may be of interest to him or her. If the individual has a favorite artist, he or she may find a bin in the music store in which that artist's recordings are kept. The individual may then browse through the various albums of the artist and read the song titles typically listed on the back of the album. If the individual recognizes the title of a song on the album that he or she likes, the individual might decide to buy the album that includes that song.

Another way of identifying an audio work or song that an individual may want to purchase is by listening to a radio broadcast of a particular song. If the individual enjoys the song, he or she typically listens for the DJ or radio announcer to announce the artist and title of the song. If this information is announced, the individual can make a mental or physical note of the song and artist. With this information, the individual can then purchase the audio work in a number of various ways, including by visiting a record store or by using a computer or web-enabled device (e.g., computer, PDA, cellular phone) to buy the recording on-line. With such a web-enabled device, the individual can log onto the World Wide Web (“WWW”), visit a Web site which offers music for sale (such as www.cdnow.com), type in the artist name, song title and/or album on which the song appears, confirm the album is being offered for sale by the Web site and then order the album for shipment to the individual's address.

One of the most frustrating moments for an individual, however, is hearing a song on the radio but missing the announcement of the artist, song title or album on which the song appears. It is equally frustrating to hear the information but not remember it later on. In such a case, it may become a near impossible task for the individual to eventually track down the song or album for purchase. The individual is often relegated to trying to sing or hum a few bars of the song to a friend who might know the song or to a record store clerk. Alternatively, the individual may simply have to wait until the song is heard again on the radio and hopefully, this time, the individual will both hear and remember the artist and name of the song. Of course, the song may not be played very often or heard by the individual for a long time.

Besides hearing songs that an individual likes on the radio, an individual can also hear music in other ways, such as when walking in a shopping mall, shopping in a store, listening to a movie soundtrack in a theater or at home, listening to music on an airplane music channel, etc. The individual, however, can again become frustrated by not being able to identify the name of the song or the artist, especially if the title and artist is never announced, such as when music is being played in a store using a music service which does not announce such information.

Moreover, even if an individual is able to ascertain the title or artist of a song that the individual desires, it can still be a difficult proposition to ultimately obtain and purchase the audio work. For instance, the individual could travel to a record store, only to find out that the album containing the song is not in stock. Or, if the user wants to make an “on-line” purchase of a CD containing the song, he or she must first log onto the Internet, navigate to a music retailer Web site, enter in the artist's name, the song or the album information, browse through possible selections returned by the Web site, select an album to be purchased and enter payment and shipment information.

The above traditional methods of identifying the title and artist of a song, such as a new or unfamiliar song, and then purchasing the song or album containing the song can be cumbersome and problematic. Accordingly, it is desirable to provide a device, system and method which simplifies the music recognition and buying process, particularly in the case which an individual is unable to readily ascertain the identity of the song title or artist after listening to all or a portion of a song.

### SUMMARY OF THE INVENTION

In accordance with one aspect of the present invention, there is provided a portable communications device for use in identifying and purchasing a full audio work based on a sampled portion of the work. The device includes an input for receiving a signal corresponding to a sampled portion of a full audio work; a memory for storing the sampled portion signal; a communications module for communicating with an audio recognition service and an audio purchasing service; an input device for accepting user commands; an interface for communicating information to a user of the device; and a processor. The processor, in response to user commands, is operative to record and store in the memory the sampled portion signal and control the communications module to: upload at least a portion of the sampled portion signal to the audio recognition service identifying the full audio work based on the sampled portion signal; enable the device to receive identification information about the identity of the full audio work and purchasing information for enabling the purchase of the full audio work; and send a purchase message to the audio purchasing service in response to the purchasing information to enable the purchase of the full audio work.

The input can include a microphone for recording the sampled portion signal or can receive the sampled portion signal via a cable or wireless transmission. The input, memory, communications module, input device, interface and processor can also be incorporated into a cellular phone, PDA or the like.

The identification information may include at least the title and artist of the work, and may also include additional related information about the audio work such as the name of the artist, information about the artist, a listing of CDs containing the audio work and the date of release of the audio work.

The audio recognition service and audio purchasing service can be provided by a single service, and the identification information and purchasing information can be received by the device from a single transmission, or from separate transmissions. The user interface may comprise a display screen or a speech module operation to convey verbal information to a user.

In another aspect of the present invention, a method of identifying and purchasing a full audio work based on a sampled portion of the work is provided. The method includes: providing a portable communications device including a memory and an interface for communicating information to a user of the device; recording and storing a signal corresponding to a sampled portion of a full audio work into the memory of the portable communications device; uploading at least a portion of the stored sampled portion signal to an audio recognition service which in turn identifies the full audio work based on the sampled portion signal; receiving at the device identification information about the identity of the full audio work from the audio recognition service and purchasing information for enabling the purchase of the full audio work from an audio purchasing service; identifying to the user through the interface (i) the identification information and (ii) the purchasing information; and sending a purchase message from the device to the audio purchasing service, in response to the purchasing information, to enable the user to purchase the full audio work.

In yet another aspect of the present invention, there is provided a method of identifying and purchasing a full audio work based on a sampled portion of the work comprising: providing a portable communications device; recording and storing a signal corresponding to a sampled portion of a full audio work into the portable communications device; identifying a full audio work based on the sampled portion signal and providing purchasing information associated with the full audio work; indicating to a user the identification information and the purchasing information; and using the purchasing information to automatically purchase the full audio work.

In a further aspect of the present invention, a portable communications device for use in identifying and purchasing a full audio work based on a sampled portion of the work is provided. The device includes: an input for receiving a signal corresponding to a sampled portion of a full audio work; a memory; a communications module for communicating with an audio recognition service; an interface for communicating information to a user of the device; and a processor operative to (i) record and store in the memory the sampled portion signal, (ii) upload at least a portion of the sampled portion signal to the audio recognition service identifying the full audio work based on the sampled portion signal, (iii) enable the device to receive and indicate to a user of the device via the interface the identity of the full audio work and purchasing information for enabling the purchase of the full audio work. Desirably, the processor is further operative to send a purchase message to an audio purchasing service in response to the purchasing information to enable the user to purchase the full audio work.

In a still further aspect of the present invention, a portable communications device for use in identifying and purchasing a full audio work based on a sampled portion of the work is provided, and includes: an input for receiving a signal corresponding to a sampled portion of a full audio work; a database of audio work comparison information for use in identifying full audio works; an interface for communicating information to a user of the device; a communications module for communicating with an audio purchasing service; and a processor operative to (i) compare the sampled portion signal against the comparison information to identify the full audio work, and (ii) indicate to a user of the portable device the identity of full audio work and present purchasing information for enabling the purchase of the full audio work to the user via the interface.

The processor may be further operative to send a purchase message to an audio purchasing service based on the purchasing information to enable the purchase the full audio work. The purchasing information may include a link, including, for example, embedded information with the identity of the full audio work and information about the user, to a Web site portal of the audio purchasing service.

The database of audio work comparison information, in a preferred embodiment, is updateable, and can be updateable via the communications module. The database may be provided in a removable memory device to allow updating of the database of audio work comparison information. A display screen may be provided to display the identity of the full audio work and purchasing information to the user or a speech module can be provided to convey verbal information about the identity of the full audio work and purchasing information to the user.

The present invention, in a still further aspect, provides a system for identifying and purchasing a full audio work based on a sampled portion of the work. The system includes: an audio recognition system for identifying a full audio work based on a sampled portion of the full audio work; an audio purchasing system for enabling the purchase of full audio works; and a portable communications device. The device includes: an interface for communicating information to a user of the device, an input for receiving a signal corresponding to the sampled portion of the full audio work, a memory for storing the sampled portion signal, a communications module for communicating with the audio recognition and purchasing systems, an input device for accepting user commands, and a processor. The processor, in response to user commands, is operative to (A) record and store in the memory the sampled portion signal and (B) control the communications module to (1) upload at least a portion of the sampled portion signal to the audio recognition system, (2) enable the device to receive information about the identity of the full audio work and purchasing information for enabling the purchase of the full audio work, and (3) send a purchase message to the audio purchasing system in response to the purchasing information to enable purchase of the full audio work.

An even further aspect of the present invention provides a portable communications device for use in identifying and purchasing a full audio work based on a sampled portion of the work, including: an input for receiving a signal corresponding to a sampled portion of a full audio work; a memory for storing the sampled portion signal; a communications module for communicating with an audio recognition service and an audio purchasing service; an input device for accepting user commands; an interface for communicating information to a user of the device; and a processor, which, in response to user commands, is operative to (i) record and store in the memory the sampled portion signal, (ii) control the communications module to download a database of audio work comparison information from the audio recognition service for use in identifying full audio works, (iii) perform a comparison routine to compare at least a portion of the sampled portion signal to the database of audio work comparison information to identify the full audio work based on the sampled portion signal, (iv) enable the device to communicate to the user through the interface identification information about the identity of the full audio work and purchasing information to enable purchase of the full audio work, and (v) send a purchase message to an audio purchasing service in response to the purchasing information to enable purchase of the full audio work.

The processor may upload at least a portion of the sampled portion signal to an audio recognition service, which in turn identifies the full audio work based on the sampled portion signal. The input may includes a microphone for recording the sampled portion signal or the input may receive the sampled portion signal via a cable or wireless transmission. The input, memory, communications module, input device, interface and processor may be incorporated into a cellular phone, PDA or the like.

The identification information may further include additional related information about the audio work, such as the name of the artist of the audio work, information about the artist in addition to the title and artist of the work, such as a listing of CDs containing the audio work and the date of release of the audio work.

The audio recognition service and audio purchasing service may provided by a single service, and the identification information and purchasing information can be received by the portable communications device from a single transmission. The identification information and purchasing information can also be received by the device from separate transmissions.

A further aspect of the present invention provides a method of identifying and purchasing a full audio work based on a sampled portion of the work, comprising providing a portable communications device; recording and storing a signal corresponding to a sampled portion of a full audio work into the portable communications device; downloading a database of audio work comparison information into the portable communications device for use in identifying full audio works; comparing at least a portion of the sampled portion signal to the database of audio work comparison information to identify the full audio work based on the sampled portion signal; identifying purchasing information associated with the full audio work; and indicating to a user the identification information and the purchasing information.

Another aspect of the instant invention provides a portable communications device for use in identifying and purchasing a full audio work based on a sampled portion of the work, comprising: means for receiving a signal corresponding to a sampled portion of full audio work; means for storing the sampled portion signal; means for communicating with an audio recognition service and an audio purchasing service; means for accepting user commands; means for communicating information to a user of the device; and processor means for (i) recording and storing in the device the sampled portion signal; (ii) uploading at least a portion of the sampled portion single to the audio recognition service for identifying the full audio work based on the sampled signal portion; (iii) enabling the device to receive and communicate to the user identification information about the identity of the full audio work and purchasing information for enabling purchase of the full audio work; and (iv) sending a purchase message to the audio purchasing service in response to the purchasing information to enable the purchase of the full audio work.

A still further aspect of the present invention provides a portable communications device for use in identifying and purchasing a full audio work based on a sampled portion of the work, comprising: means for receiving a signal corresponding to a sampled portion of a full audio work; means for storing the sampled portion signal; means for communicating with an audio recognition service and an audio purchasing service; means for accepting user commands; means for communicating information to a user of the device; and processor means for (i) recording and storing in the device the sampled portion signal; (ii) downloading a database of audio work comparison information from the audio recognition service for identifying full audio works; (iii) comparing at least a portion of the sampled portion signal to the database of audio work comparison information to identify the full audio work based on the sampled portion signal; (iv) communicating to the user identification information about the identity of the full audio work and purchasing information to enable purchase of the full audio work; and (v) sending a purchase message to an audio purchasing service in response to the purchasing information to enable purchase of the full audio work.

### BRIEF DESCRIPTION OF THE DRAWINGS

FIG. 1 is a schematic diagram of the main components of a portable communications device (“PCD”) in accordance with the present invention.

FIG. 2 is a flow chart of the main steps followed in a method of identifying and purchasing an audio work in accordance with the present invention.

FIG. 3 depicts a series of screen displays shown to a user when identifying and purchasing an audio work using a PCD in accordance with the present invention.

FIG. 4 shows one embodiment of the PCD incorporated into a cellular phone.

FIG. 5 shows another embodiment of the PCD incorporated into a PDA.

### DETAILED DESCRIPTION

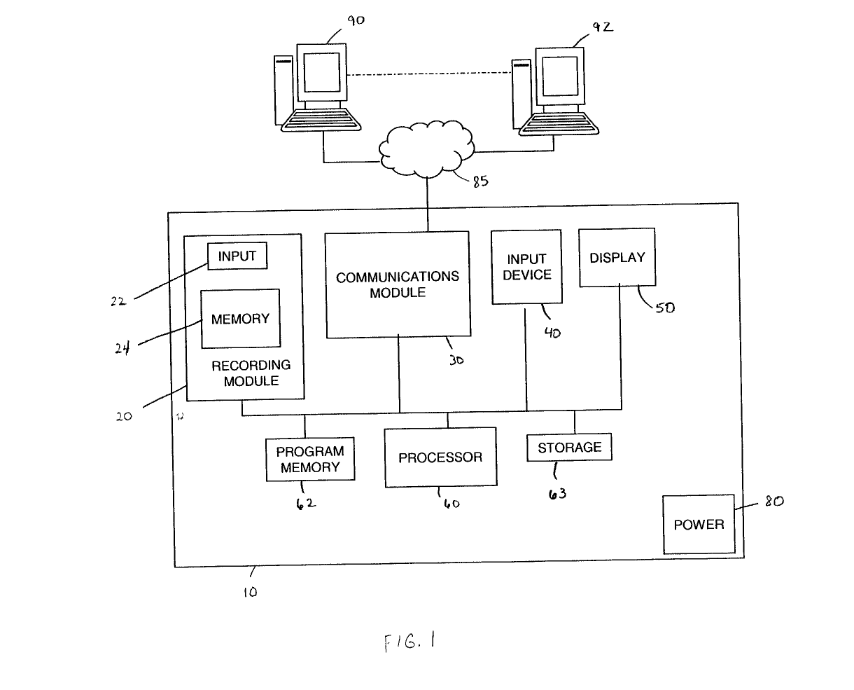

Referring to FIG. 1, there is shown a schematic diagram of one embodiment of a portable communications device (“PCD”) for use in identifying and purchasing a full audio work in accordance with the present invention. The PCD, generally designated as 10, includes a recording module 20, communications module 30, input device 40, display 50, processor 60 and power circuit 80. Processor 60 communicates with and controls recording module 20, communication module 30, input device 40 and display 50 by way of a communications bus 70.

Recording module 20 provides the necessary circuitry and components for recording and saving a sample portion of audio, including an input 22 for receiving a signal corresponding to the sampled portion of the audio work and a memory 24 for storing the sampled portion. As well-known by those skilled in the art, various other components can be included in the recording module to enable recording of sample portion of an audio work, such as A/D converters, special purpose processors (e.g., MPEG compressor/decompressor), etc. The input 22 may include or incorporate one or more of various types of inputs, including, for example, a microphone, data port, jack or connector to accept audio input. Audio input can come from any source, such as from an external microphone, RCA cable, coaxial cable, optical connection, etc. Input 22 can also include an infrared (IR) or radio frequency (RF) receiver for receiving audio signals sent by wireless IR or RF transmissions. For example, one PCD may record and store an audio sample, which sample can then be sent via IR or RF transmission to another PCD.

Memory 24 of recording module 20 stores the recorded sampled portion of a full audio work. The memory may comprise any type or format of memory including, for example, solid-state memory such as any form of static RAM or dynamic RAM, programmable ROM such as an EEPROM, etc. It may also include any form of magnetic and/or optical memory such as a hard drive, optical disk, CD-R, etc. The memory may also be removable and include, for instance, a memory stick, memory card, floppy disk, removable hard drive, minidisc, optical disk, etc.

Communications module 30 provides the main communication functions to allow PCD 10 to communicate with various services such as an audio recognition service 90 and/or audio purchasing service 92 as discussed in further detail below. The communications module 30 may comprise, for example, the various necessary electronic components used for communications in a cellular telephone, modem, wireless modem, satellite transmitter/receiver, etc. Preferably, the communications module is compatible with all types of cellular telephone technology including CDMA, WCDMA, G3, GSM, etc.

Device 10 further includes an input device 40 to allow the user to enter commands and choose selections presented. The input device can include any type of device for allowing input of user commands, including, for example, a keypad, touch sensitive screen, keyboard, microphone for voice commands, thumbwheel, touch pad, pointing stick, trackball, joystick, etc.

PCD 10 further includes a display 50 for displaying information to the user. Display 50 can be any type of display to display information to the user and can comprise, for example, an LCD screen, CRT, LEDs, etc. for displaying information to the user. Display 50 can also be replaced or augmented with any type of interface for communicating information to a user of the PCD. For example, display 50 can comprise a speech synthesis module for conveying verbal information to a user in lieu of or in addition to visual information.

Microprocessor 60 is provided for controlling and interfacing with the various modules, input device, display and memories. Microprocessor 60 can, for example, receive its instructions from a program stored in a program memory 62. Program memory 62 can include, for example, typical memories such as RAM, ROM, flash, etc. A mass storage device 63 can also be provided which can replace or augment memories 24 and 62. Mass storage device 63 can be configured store information sent to PCD 10 from outside sources, such as the audio recognition service and audio purchasing service. Mass storage 63 may store downloaded audio works obtained or purchased from the audio purchasing service 92.

PCD 10 further includes a power supply 80 for supplying power to the device. Power supply 80 can consist of, for example, disposable or rechargeable batteries and/or an AC adapter port or DC port for connection to a source of AC or DC power.

In a preferred arrangement, PCD 10 communicates with audio recognition service 90 and/or audio purchasing service 92 through a network 85, which preferably comprises a wireless communications network such as those frequencies operated by wireless devices, including, for example, 800 megahertz, AMPS, NAMPS, TDMA, CDMA, GSM, PCS, etc. The communications take place through communications module 30 of PCD 10.

In one embodiment, a separate audio recognition service 90 and a separate audio purchasing service 92 are provided. In such a case, PCD 10 is operative to upload a sampled portion of an audio work to audio recognition service 90, which can comprise, for instance, a service accessible by the Web or by dial-in over the communications network. Upon receipt of the sampled portion, audio recognition service 90 sends back identification information to PCD 10 relating to the identity of the full audio work identified by the audio recognition service. Such information can include, for example, the title of the work, artist and albums on which the work appears. Further, audio recognition service 90 can provide purchasing information to PCD 10 to enable the user to readily purchase the full audio work from audio purchasing service 92. For example, audio recognition service 90 can send a Web site link containing the Web site address of audio purchasing service 92. Preferably, the link includes unique identification information of the identified songs such that upon selecting the link, the user will be taken to a Web site at audio purchasing service 92 which will automatically display the available albums for purchase, along with additional information if desired. The link can also include identification information about the user so that the user need not log in every time at the Web site. Alternatively, the link can include a phone number for dial-up into the audio purchasing service 92 and the audio work can be purchased by using touchtone or voice commands.

In an alternate embodiment, audio recognition service 90 and audio purchasing service 92 can be combined as a single service such that the audio work identification information and purchasing information can be sent from the combined audio recognition/purchasing service.

In still another embodiment, PCD 10 itself can contain the necessary software and algorithms for determining the identification of the full audio work. For example, once a week, PCD 10 can download a database of comparison information so as to allow PCS 10 to directly compare the sampled portion of the full audio work to the downloaded comparison information to enable identification of the full audio work directly within PCD 10. As one example, information representative of each week's top 100 popular songs can be downloaded to PCD 10 and stored in database in mass storage device 63. Such downloading can occur at regular intervals, such as weekly, or only upon request by the user.

Alternatively, the database can be supplied on a removable memory (such as a floppy disk, memory stick, flash card, etc.) that can be inserted into or connected to the PCD.

Thus, if the sampled portion captured by the user by recording module 20 matches with the database information representative of the top 100 songs of the week, PCD 10 can identify such audio work internally without separately communicating with audio recognition service 90. Purchase information for the top 100 songs can also be stored in the database to enable ready purchasing of the audio work form the audio purchasing service. If, however, the user records a portion of an audio work that is not readily identifiable within PCD 10, the user can alternatively be given the option to send such information to the audio recognition service for remote identification of the internally unrecognized audio work.

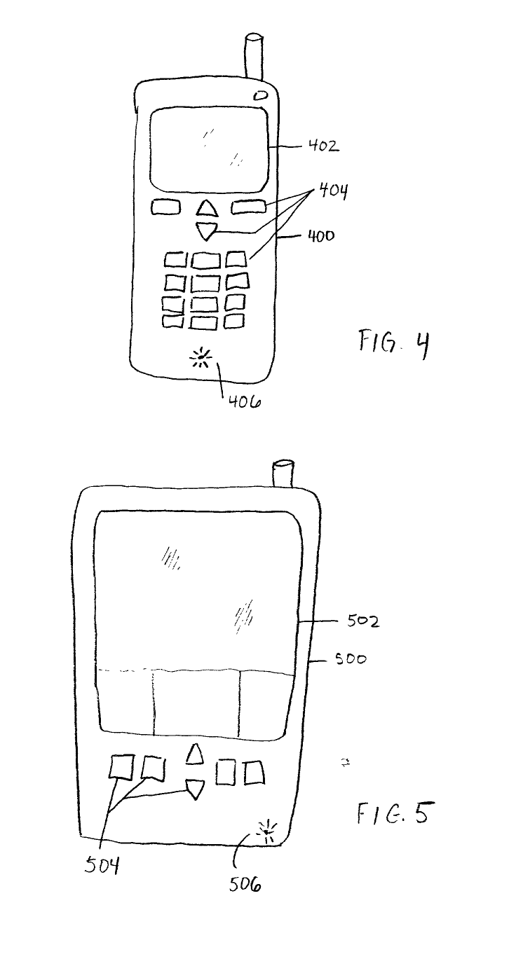

In one preferred configuration as shown in FIG. 4, the PCD can be incorporated into a cellular telephone, such as cellular telephone 400, which includes a display 402, user selectable keys 404 for the input device and microphone 406. In such a case, a typical cellular telephone may be modified to include the recording module for recording a sample portion of a full audio work. The cell phone may also be modified to include any additional memory necessary for storing information as described above for use in connection with the identification and purchasing of audio works. Microphone 406 could serve as a dual function to provide for both normal telephone communications and to provide the input function for recording a sample of an audio work. Alternatively, a separate built-in microphone or other input jack (not shown) could be provided elsewhere on the cellular telephone for recording the sample portion.

In another preferred arrangement, as shown in FIG. 5 the PCD 10 can be incorporated into a personal digital assistant (PDA), such as the Sony Clié or the 3COM Palm Pilot. In such as case, PDA 500 includes, for example, display screen 502, user input keys 504, and adds a microphone 506 for enabling audio input into the recording module. The PDA could include an integrated wireless modem or an add-in module for a wireless modem.

Of course, the PCD can also be configured with various other portable devices, such as an MP3 player, which could receive and play back full audio works downloaded from the audio purchasing service.

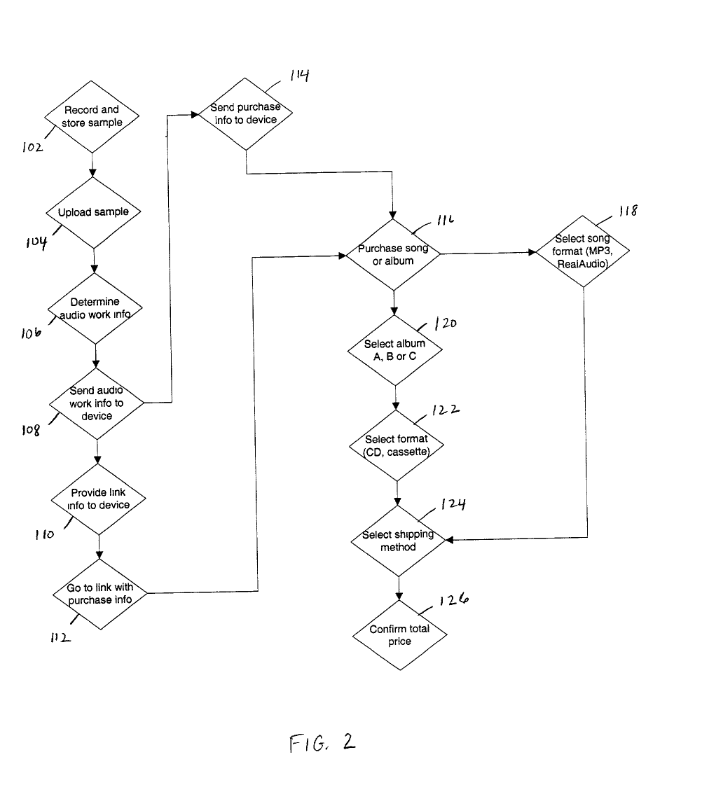

Referring to FIG. 2, a flow diagram of one preferred mode of operation of the PCD is shown. At step 102, the user first records a signal representation of a sampled portion of a full audio work into memory 24 of recording module 20 or into storage device 63. For example, while listening to the radio, the user can use the input device 40, such as a keypad, to select a recording function to record a sample of the current music being heard. The sample is typically a short clip of the audio work, such as a 30 second sample of the full audio work. The recorded sample portion can be stored in memory in any number of formats, such as a .wav file, MP3 file or other file formats.

Next, at step 104, the user operates the input device by selecting an upload function to upload the sample stored in memory to an audio recognition service. The entire sample can be sent or just a portion of the sample can be sent if desired. For instance, if the user records a 30-second portion, a lesser amount, such as the last 25 seconds, can be uploaded.

Next, at step 106, the uploaded sampled portion is analyzed at the audio recognition service and compared against a database of audio works. The audio recognition service possesses the necessary software with the requisite algorithms to perform acoustic pattern recognition to enable the comparison of the sampled portion of the audio work to a library of information indicative of full audio works. The particular type of acoustical pattern recognition used by the audio recognition service is not critical so long as the service is able to identify the full audio work from the sampled portion. One such recognition technology that can be used, for example, is the New Zealand Digital Library MELody InDEX (“MELDEX”) system, which is able to accept acoustical input, transcribe it into music notation, and then compare the notation against a database for audio works that contain the acoustical pattern or patterns similar to it. Besides the MELDEX system, other database searching techniques can be used, such as comparing portions of a digital audio file against a database of files of corresponding full audio works.

Once the audio work is recognized by the audio recognition service, at step 108, the audio recognition service sends identification information about the identity of the full audio work to the communications device. Upon receiving the identification information, it is displayed for viewing by the user.

In an alternate embodiment, the PCD can identify the full audio work internally without uploading the sampled portion to the audio identification service. In such as case, the PCD records and stores in memory the sampled portion signal, and uses the communications module to download a database of audio work comparison information from an audio recognition service for use in identifying full audio work. The audio work comparison information can also be loaded into the PCD via removable memory device such as a memory stick or floppy disk. The PCD then performs a comparison routine operative to compare at least a portion of the sampled portion signal to the database of audio work comparison information to identify the full audio work based on the sampled portion signal.

After step 108, two possibilities can occur. First, a step 110, in the case where a separate audio purchasing service is used, the audio recognition service can provide link information to the audio purchasing service. Then, at step 112, the user can select that link along with any purchase selection information the user may be able to select prior to sending the length to the audio purchasing service. This sending can also be initiated automatically without user commands. If no separate audio purchasing service is used, purchasing information can be sent directly to the user at step 114.

In either event, at step 116, the user may then purchase the album or CD on which the song appears or purchase just the song such as by purchasing an MP3 download. At step 120, the user can select, for example, an album on which the audio work appears. Next, at step 122, the user can select a format of the album such as CD, cassette, MP3, etc. At step 124, the user selects the shipping method, such as UPS, overnight, regular mail, etc. and a total price is confirmed at step 126.

After step 116, rather than selecting an album, the user can select a song format for the download of a single song or an entire album in a digital downloadable format such as MP3 or real audio formats. In such a case, the shipping method may be via download to an E-mail address or downloading the audio work onto a floppy disk or CD-R, which can be sent to the user.

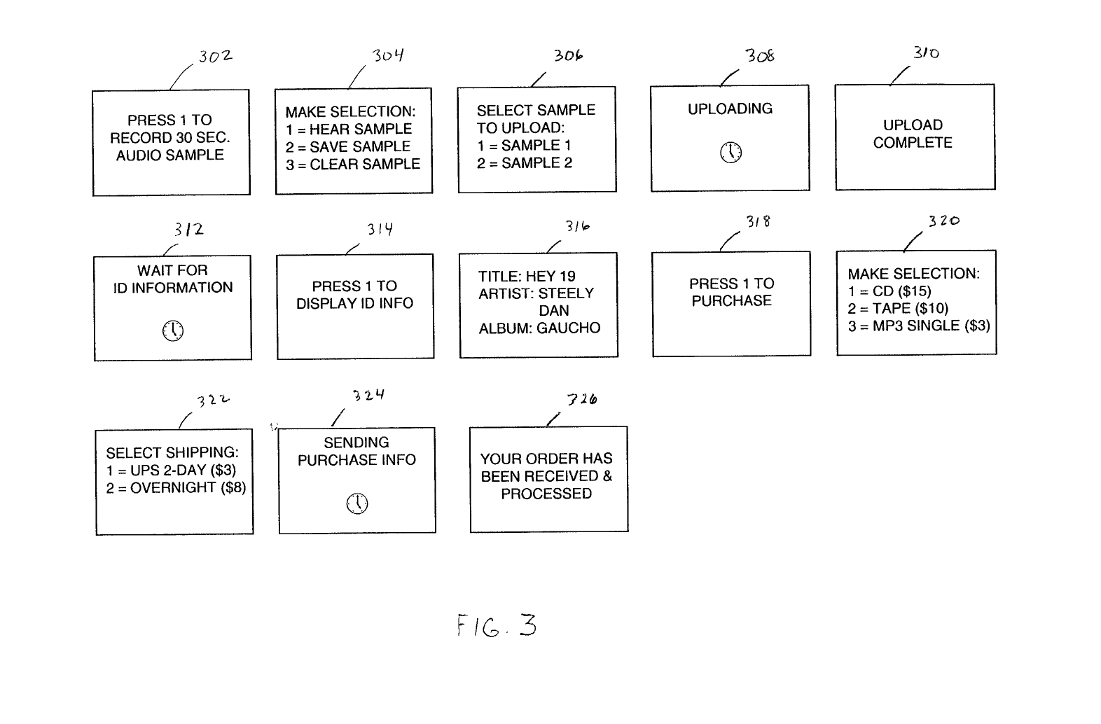

Turning now to FIG. 3, there is shown a series of screen displays that, in one embodiment, could be presented to the user via display 50. The displays in FIG. 3 may, for example, be shown on an LCD screen of a PCD combined with a cellular telephone or PDA such as the device shown in FIGS. 4 and 5.

The first screen displayed to the user, screen 302, requests that the user select a key, such as the key marked “1”, to record a 30 second audio sample of the music that the user is listening to. In the case of PCD 400 of FIG. 4, the audio sample would be recorded by use of microphone 406. Next, the user is presented with display 304, which asks for a selection to be made by the user including hearing the sample that was recorded (selection 1), saving the sample into memory (selection 2) or clearing the sample (selection 3), in the case that the user wants to re-record the sample.

Once one or more samples have been saved into the PCD, the user is then presented with screen 306 which requests that the user select a sample to upload to the audio identifying service. If multiple samples are stored, the user can select one of the samples he or she wants to upload. Upon selecting the sample to upload, the user is next presented with screen 308 informing the user that the sample is being uploaded. Next, at screen 310, the user is informed that the upload process has been completed.

Next, the user is presented with screen 312, which informs the user that he or she should wait for the identification information of the audio sample to be downloaded to the PCD. At screen 314, the user is next prompted to make a selection to display the identification information received from the audio identification service. Upon making that selection, the user is presented with screen 316, which lists the identification received. As shown in screen 316, the user can see the title, artist and album on which the audio work appears. At this stage, the user can be presented with additional menus or can scroll to display additional information such as other albums on which the song appears, other albums by the artist, release information, similar artists, etc.

Next, at screen 318, the user is requested to make a purchase. The user is then taken to screen 320, in which the user can select from one or more items in which to purchase including, for example, purchasing a CD including the song, a tape including the song, an MP3 single, etc. If, for example, the user selects an MP3 single, the user may be given a choice of downloading the single to the PCD, receiving the MP3 file as an E-mail attachment to the user's E-mail address or receiving a disk of CD-R of the MP3 file.

Next, if the user selects an object for purchase that requires shipping, the user can select the shipping mode and can be shown the cost for each shipping method. At screen 324, the user is informed that the purchasing information is being sent to the audio purchasing service (which may be separate from the audio identification service or be a part of the audio identification service). Finally, the user is informed at screen 326 that the order has been received and is being processed.

Once the audio work is recognized, the user can then purchase the complete audio work in other ways. For example, if the user is using a PCD with a web-enabled browser program, the audio recognition service, upon recognizing the audio work and sending the user the identity information about the song, can also provide a link to the audio purchasing service. Upon selection of the link by the user on the PCD, the user's web browser on the PCD can be directed to an audio purchasing Web site along with a unique identifier of the song, which identifier can then be used by the audio purchasing Web site to automatically present items to purchase (e.g., CD, cassette, MP3 download) or additional information about the song, artist, album, etc.

In addition to the ability to purchase the full audio work upon identification, the user can also be given an option to save bookmarks in the PCD of audio works identified for later purchase.

The PCD can also receive other related information about the identified song, such as the artist, albums on which the song appears, a universal reference number of the song, release date of the song and/or albums, all of the tracks on the albums that include the song, concert tour information for the artist, articles about the artist, names of similar recommended artists, etc. This information can be downloaded directly to the PCD with the name of the song from the music recognition service and/or music purchasing service. Alternatively, the related information can be delivered to the PCD only upon request by the user. For example, the user may only wish to know what albums the song appears on and not desire information about concert dates for the artist.

The music recognition service and/or music purchasing service can provide this additional related information, either automatically or upon request, from its own database or can provide the user with one or more links (e.g., hypertext links selectable by the device) to other Web sites. These other Web sites could have prior arrangements for cooperating directly with the recognition service and/or music purchasing service. Alternatively, or in addition, the recognition service and/or music purchasing service may provide the PCD with links to other regularly accessible music-related Web sites, including information music Web sites such as Muse (www.muse.ie) or AMG (www.allmusic.com), or Web sites that can find similar music or make recommendations of other artists if you like a certain artist such as MongoMusic (www.mongomusic.com) or CDNow (www.cdnow.com).

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A portable communications device for use in identifying and purchasing a full audio work based on a sampled portion of the work comprising:
(a) an input for receiving a signal corresponding to a sampled portion of a full audio work;
(b) a memory for storing the sampled portion signal;
(c) a communications module for communicating with an audio recognition service and an audio purchasing service;
(d) an input device for accepting user commands;
(e) an interface for communicating information to a user of the device; and
(f) a processor, which, in response to user commands, is operative to (i) record and store in said memory the sampled portion signal and (ii) control said communications module to (A) upload at least a portion of the sampled portion signal to said audio recognition service identifying the full audio work based on the sampled portion signal, (B) enable the device to receive identification information about the identity of the full audio work and purchasing information for enabling the purchase of the full audio work, and (C) send a purchase message to the audio purchasing service in response to said purchasing information to enable the purchase of the full audio work.

2. The portable communications device as claimed in claim 1, wherein said input includes a microphone for recording the sampled portion signal.

3. The portable communications device as claimed in claim 1, wherein said input receives the sampled portion signal via a cable or wireless transmission.

4. The portable communications device as claimed in claim 1, wherein said input, memory, communications module, input device, interface and processor are incorporated into a cellular phone.

5. The portable communications device as claimed in claim 1, wherein said input, memory, communications module, input device, interface and processor are incorporated into a PDA.

6. The portable communications device as claimed in claim 1, wherein said identification information includes at least the title and artist of the work.

7. The portable communications device as claimed in claim 6, wherein said identification information includes additional related information about the audio work.

8. The portable communications device as claimed in claim 7, wherein said additional related information includes one or more of the name of the artist of the audio work, information about the artist, a listing of CDs containing the audio work and the date of release of the audio work.

9. The portable communications device as claimed in claim 1, wherein said audio recognition service and audio purchasing service are provided by a single service.

10. The portable communications device as claimed in claim 9, wherein said identification information and said purchasing information are received by the portable communications device from a single transmission.

11. The portable communications device as claimed in claim 9, wherein said identification information and said purchasing information are received by the portable communications device from separate transmissions.

12. The portable communications device as claimed in claim 1, wherein said user interface comprises a display screen.

13. The portable communications device as claimed in claim 1, wherein said user interface comprises a speech module operation to convey verbal information to a user.

14. A method of identifying and purchasing a full audio work based on a sampled portion of the work comprising:
(a) providing a portable communications device including a memory and an interface for communicating information to a user of the device;
(b) recording and storing a signal corresponding to a sampled portion of a full audio work into said memory of said portable communications device;
(c) uploading at least a portion of the stored sampled portion signal to an audio recognition service which in turn identifies the full audio work based on the sampled portion signal;
(d) receiving at said device identification information about the identity of the full audio work from the audio recognition service and purchasing information for enabling the purchase of the full audio work from an audio purchasing service;
(e) identifying to the user through said interface (i) said identification information and (ii) said purchasing information; and
(f) sending a purchase message from said device to the audio purchasing service, in response to said purchasing information, to enable the user to purchase the full audio work.

15. A method of identifying and purchasing a full audio work based on a sampled portion of the work comprising:
(a) providing a portable communications device;
(b) recording and storing a signal corresponding to a sampled portion of a full audio work into said portable communications device;
(c) identifying a full audio work based on the sampled portion signal and providing purchasing information associated with the full audio work;
(d) indicating to a user said identification information and said purchasing information; and
(e) using said purchasing information to automatically purchase the full audio work.

16. A portable communications device for use in identifying and purchasing a full audio work based on a sampled portion of the work comprising:
(a) an input for receiving a signal corresponding to a sampled portion of a full audio work;
(b) a memory;
(c) a communications module for communicating with an audio recognition service;
(d) an interface for communicating information to a user of the device; and
(e) a processor operative to (i) record and store in said memory the sampled portion signal, (ii) upload at least a portion of the sampled portion signal to said audio recognition service identifying the full audio work based on the sampled portion signal, (iii) enable the device to receive and indicate to a user of the device via said interface the identity of the full audio work and purchasing information for enabling the purchase of the full audio work.

17. The portable communications device as claimed in claim 16, wherein said processor is further operative to send a purchase message to an audio purchasing service in response to said purchasing information to enable the user to purchase the full audio work.

18. A portable communications device for use in identifying and purchasing a full audio work based on a sampled portion of the work comprising:
(a) an input for receiving a signal corresponding to a sampled portion of a full audio work;
(b) a database of audio work comparison information for use in identifying full audio works;
(c) an interface for communicating information to a user of the device;
(d) a communications module for communicating with an audio purchasing service; and
(e) a processor operative to (i) compare the sampled portion signal against said comparison information to identify the full audio work, and (ii) indicate to a user of the portable device the identity of full audio work and present purchasing information for enabling the purchase of the full audio work to the user via said interface.

19. The portable communications device as claimed in claim 18, wherein said processor is further operative to send a purchase message to an audio purchasing service based on said purchasing information to enable the purchase the full audio work.

20. The portable communications device as claimed in claim 19, wherein said purchasing information comprises a link to a Web site portal of said audio purchasing service.

21. The portable communications device as claimed in claim 20, wherein said link includes embedded information including the identity of the full audio work and information about the user.

22. The portable communications device as claimed in claim 18, wherein said database of audio work comparison information is updateable.

23. The portable communications device as claimed in claim 22, wherein said database is updateable via said communications module.

24. The portable communications device as claimed in claim 22, wherein said database is provided in a removable memory device to allow updating of said database of audio work comparison information.

25. The portable communications device as claimed in claim 18, further comprising a display screen to display the identity of the full audio work and purchasing information to the user.

26. The portable communications device as claimed in claim 18, further comprising a speech module operative to convey verbal information about the identity of the full audio work and purchasing information to the user.

27. A system for identifying and purchasing a full audio work based on a sampled portion of the work comprising:
(a) an audio recognition system for identifying a full audio work based on a sampled portion of the full audio work;
(b) an audio purchasing system for enabling the purchase of full audio works; and
(c) a portable communications device comprising:
i. an interface for communicating information to a user of the device,
ii. an input for receiving a signal corresponding to the sampled portion of the full audio work,
iii. a memory for storing the sampled portion signal,
iv. a communications module for communicating with said audio recognition and purchasing systems,
v. an input device for accepting user commands, and
vi. a processor, which, in response to user commands, is operative to (A) record and store in said memory the sampled portion signal and (B) control said communications module to (1) upload at least a portion of the sampled portion signal to said audio recognition system, (2) enable said device to receive information about the identity of the full audio work and purchasing information for enabling the purchase of the full audio work, and (3) send a purchase message to said audio purchasing system in response to said purchasing information to enable purchase of the full audio work.

28. A portable communications device for use in identifying and purchasing a full audio work based on a sampled portion of the work comprising:
(a) an input for receiving a signal corresponding to a sampled portion of a full audio work;
(b) a memory for storing the sampled portion signal;
(c) a communications module for communicating with an audio recognition service and an audio purchasing service;
(d) an input device for accepting user commands;
(e) an interface for communicating information to a user of the device; and
(f) a processor, which, in response to user commands, is operative to (i) record and store in said memory the sampled portion signal, (ii) control said communications module to download a database of audio work comparison information from said audio recognition service for use in identifying full audio works, (iii) perform a comparison routine to compare at least a portion of the sampled portion signal to said database of audio work comparison information to identify the full audio work based on the sampled portion signal, (iv) enable the device to communicate to the user through said interface identification information about the identity of the full audio work and purchasing information to enable purchase of the full audio work, and (v) send a purchase message to an audio purchasing service in response to said purchasing information to enable purchase of the full audio work.

29. The portable communications device as claimed in claim 28, wherein said processor is further operative to upload at least a portion of the sampled portion signal to an audio recognition service which in turn identifies the full audio work based on the sampled portion signal.

30. The portable communications device as claimed in claim 28, wherein said input includes a microphone for recording the sampled portion signal.

31. The portable communications device as claimed in claim 28, wherein said input receives the sampled portion signal via a cable or wireless transmission.

32. The portable communications device as claimed in claim 28, wherein said input, memory, communications module, input device, interface and processor are incorporated into a cellular phone.

33. The portable communications device as claimed in claim 28, wherein said input, memory, communications module, input device, interface and processor are incorporated into a PDA.

34. The portable communications device as claimed in claim 28, wherein said identification information further includes additional related information about the audio work in addition to the title and artist of the work.

35. The portable communications device as claimed in claim 34, wherein said additional related information includes one or more of the name of the artist of the audio work, information about the artist, a listing of CDs containing the audio work and the date of release of the audio work.

36. The portable communications device as claimed in claim 28, wherein said audio recognition service and audio purchasing service are provided by a single service.

37. The portable communications device as claimed in claim 29, wherein said identification information and said purchasing information are received by the portable communications device from a single transmission.

38. The portable communications device as claimed in claim 29, wherein said identification information and said purchasing information are received by the portable communications device from separate transmissions.

39. A method of identifying and purchasing a full audio work based on a sampled portion of the work comprising:
(a) providing a portable communications device;
(b) recording and storing a signal corresponding to a sampled portion of a full audio work into said portable communications device;
(c) downloading a database of audio work comparison information into said portable communications device for use in identifying full audio works;
(d) comparing at least a portion of the sampled portion signal to said database of audio work comparison information to identify the full audio work based on the sampled portion signal;
(e) identifying purchasing information associated with the full audio work; and
(f) indicating to a user said identification information and said purchasing information.

40. A portable communications device for use in identifying and purchasing a full audio work based on a sampled portion of the work comprising:
(a) means for receiving a signal corresponding to a sampled portion of full audio work;
(b) means for storing the sampled portion signal;
(c) means for communicating with an audio recognition service and an audio purchasing service;
(d) means for accepting user commands;
(e) means for communicating information to a user of the device; and
(f) processor means for (i) recording and storing in said device the sampled portion signal; (ii) uploading at least a portion of the sampled portion single to said audio recognition service for identifying the full audio work based on the sampled signal portion; (iii) enabling the device to receive and communicate to the user identification information about the identity of the full audio work and purchasing information for enabling purchase of the full audio work; and (iv) sending a purchase message to the audio purchasing service in response to said purchasing information to enable the purchase of the full audio work.

41. A portable communications device for use in identifying and purchasing a full audio work based on a sampled portion of the work comprising:
(a) means for receiving a signal corresponding to a sampled portion of a full audio work;
(b) means for storing the sampled portion signal;
(c) means for communicating with an audio recognition service and an audio purchasing service;
(d) means for accepting user commands;
(e) means for communicating information to a user of the device; and
(f) processor means for (i) recording and storing in said device the sampled portion signal; (ii) downloading a database of audio work comparison information from said audio recognition service for identifying full audio works; (iii) comparing at least a portion of the sampled portion signal to said database of audio work comparison information to identify the full audio work based on the sampled portion signal; (iv) communicating to the user identification information about the identity of the full audio work and purchasing information to enable purchase of the full audio work; and (v) sending a purchase message to an audio purchasing service in response to said purchasing information to enable purchase of the full audio work.
